(19) United States
(12) Patent Application Publication
(10) Pub. No.: US 2010/0276589 A1
(43) Pub. Date: Nov. 4, 2010

(54) Atmospheric pressure ion source moving transport interface for a mass spectrometer

(75) Inventors: Richard Garrett McKay, Hockessin, DE (US); Charles Nehemiah McEwen, Newark, DE (US)

Correspondence Address: M&M Mass Spec. Consulting LLC, P.O. Box 191, Hockessin, DE, 19707, US

(73) Assignee: M&M MASS SPEC CONSULTING LLC, HOCKESSIN, DE (US)

(21) Appl. No.: 12/387,590

(22) Filed: May 4, 2009

(51) Int. Cl. H01J 49/00; G01J 3/10

(52) U.S. Cl. 250/288; 250/504 R

(57) ABSTRACT

An atmospheric pressure (AP) mass spectrometry ion source able to ionize analytes in liquid effluents from interfaced liquid separation techniques and from individual containers, as in microtiter plates, by direct introduction of the analyte into the ion source using a moving ribbon, wire, or belt with vaporization of the analyte and subsequent ionization using an electric discharge or photoionization. The AP source may also incorporate atmospheric pressure chemical ionization (APCI), photoionization (APPI) and/or electrospray ionization (ESI), techniques that are commercially available. The source facilitates ionization of volatile and semivolatile compounds by applying heat from a gas stream to vaporize analyte entering the ionization region on a moving transport device. Solvent removal prior to sample entering the ionization region enables ionization of a wider range of compounds than liquid introduction APCI or APPI. The source is also capable of ionizing non-volatile compounds in solution by electrospray ionization, thus the combination provides almost universal ionization for organic compounds.

### PATENTS CITED DIRECTLY RELATING TO THIS INVENTION

U.S. Pat. No. 4,055,987, William H. McFadden, Finnigan Corp., “Liquid Chromatograph/Mass Spectrometry Interface”.

U.S. Pat. No. 4,867,947A, Brian D. Andresen and Eric R. Fought, Sepragen Corp., “Interface for Liquid Chromatograph-Mass Spectrometer”.

### NON-PATENT CITATIONS DIRECTLY RELATING TO THIS INVENTION

Smith, R. D. et al., Deposition Method for Moving Ribbon Liquid Chromatograph-Mass Spectrometer Interfaces, Anal. Chem., 1981, 53, 739-740.

Smith, R. D. et al., Liquid Chromatography-Mass Spectrometry with Electron Impact and Fast Atom Bombardment with a Ribbon Storage Device, Anal. Chem., 1981, 53, 1603-1611.

Hayes, M. J. et al., Moving Belt Interface with Spray Deposition for Liquid Chromatography/Mass Spectrometry, Anal. Chem., 1983, 55, 1745-1752.

Games, D. C. et al., A Comparison of Moving Belt Interfaces for Liquid chromatography-Mass Spectrometry, Biomed. Mass Spectrom., 1984, 11, 87-95.

Stout, S. D. et al., Simplified Moving Belt Interface for Liquid chromatography/Mass Spectrometry, Anal. Chem., 1985, 57, 1783-1786.

Mizuno, T. et al., Development of double Belt Type LC/MS Interface without Memory Effect, Anal. Sci., 1988, 4, 241-246.

Barefoot, A. C. et al., Packed Capillary Liquid Chromatography/Mass Spectrometry Using a Moving Belt Interface, Biomed. Environ. Mass Spectrom., 1989, 18, 77-82.

Horning, E. C., et al., New Picogram Detection System Based on a Mass Spectrometer with an External Ionization Source at Atmospheric Pressure, Anal. Chem., 1973, 45, 936-943.

Dzidic, et al., Comparison of Positive Ions Formed in Nickel-63 and Corona Discharge Ion Sources using Nitrogen, Argon, Isobutene, Ammonia, and Nitric Oxide as Reagents in Atmospheric Pressure Ionization Mass Spectrometry, Anal. Chem., 1976, 48, 1762-1768.

McEwen, C. N., et al., Analysis of Solids, Liquids and Biological Tissue Using Solids Probe Introduction at Atmospheric Pressure on Commercial LC/MS Instruments, Anal. Chem., 2005, 77, 7826-7831

### FIELD OF INVENTION

This invention relates to an atmospheric pressure ionization (API) source comprising ionization of liquid effluents either by electrospray (ESI) or atmospheric pressure chemical ionization (APCI) and also facilitates rapid analysis of solid or liquid samples by direct introduction into the API source on a moving ribbon, wire, or belt of an analyte transport device (ATD) to permit ionization and subsequent mass separation of the ions by a mass spectrometer. This invention also relates to a method, using the ionization source, of introducing the analyte on the surface of a heat tolerant material into a heated nitrogen stream which may emanate from either a commercial ESI or APCI probe so that the analyte is vaporized with subsequent ionization using either a discharge or photoionization. This invention also relates to a method, using the ionization source, of increasing the compounds that can be ionized in an API source by eliminating solvent that hinders or prevents ionization of nonpolar analytes. This invention also relates to use of automation such as robotics or liquid of gas chromatographic auto-samplers to place or inject samples, usually in solution, onto the moving ribbon, wire, or belt of the ATD for subsequent vaporization and ionization in an API source. This invention also relates to depositing the eluent from a liquid chromatograph onto the moving ribbon, wire, or belt of the ATD for subsequent vaporization of the chromatographically separated components of a mixture and ionization at atmospheric pressure with analysis using a mass spectrometer or ion mobility spectrometer. This invention also relates to removing the solvent from samples placed on the moving ribbon, wire, or belt of the ATD before the sample enters the housing that encloses the atmospheric pressure ion source.

As used in this invention a moving ribbon, wire, or belt, hereafter called a moving transport device (ATD) are a means of introducing sample into the ionization region of a mass spectrometer. Sample can be placed on the ATD using robotics that are commonly used in mass spectrometry or auto-samplers commonly used with separation devices such as liquid chromatographs, or by hand with, for example, a pipette. The ESI and APCI probe assemblies are commercially available and present on most API sources. The ATD assembly used to introduce samples into the API source is similar in many respects to so called moving belt interface devices used to introduce samples into electron or chemical ionization sources that operate under vacuum conditions, except that vacuum locks are not required for the ATD which greatly simplifies the device. Additionally, ionization is at atmospheric pressure which makes the method useful for modern mass spectrometers used in combination with liquid chromatography. The ATD also preferably uses the heated gas stream, usually nitrogen, from the commercially available ESI or APCI probes for sample vaporization rather than resistive heating of the surface containing the sample.

Employing the ionization source of the present invention, a single atmospheric pressure ionization mass spectrometer of any type is made capable of ionizing with high sensitivity low-polarity compounds that are difficult to ionize using the commonly available ionization methods of ESI or APCI. In combination with robotics or auto-samplers, the method allows rapid automatic introduction of samples without solvent into the atmospheric pressure ionization region for analysis by mass spectrometry. The method can also be used in combination with liquid separation techniques to facilitate ionization of low polarity compounds with high sensitivity.

### BACKGROUND

As used herein, the term moving transport device (ATD) refers to a device incorporating a heat resistant ribbon, wire or belt that moves analyte from the exterior of the atmospheric pressure ion (API) source of a mass spectrometer through the ion source housing to the interior of the source and a flange assembly that holds the ATD to the ion source housing. The term ESI probe refers to a commercially available device for ionization of analyte in a liquid stream using a high voltage that is interfaced to a mass spectrometer through the API source. The term APCI probe refers to a commercially available device for ionization of analyte in a liquid by nebulizing the liquid into droplets and vaporizing the liquid droplets with subsequent ionization of the vaporized analyte using a corona discharge with mass analysis by a mass spectrometer. The current practice in mass spectrometry is to have APCI and/or ESI ionization methods, both of which ionize analyte from a liquid stream. No commercial API instrument includes an ATD for rapid introduction of samples into the API source. Additionally, the ATD device is capable of removing solvent before the analyte enters the ion source housing so that ion suppression by solvent is eliminated, thus increasing the types of vaporizable compounds which can be analyzed relative to other liquid introduction methods.

Atmospheric pressure ionization mass spectrometers (APIMS) instruments currently available lack flexibility. They primarily accept only liquid effluent from which analyte ions are produced by electrospray ionization, atmospheric pressure chemical ionization, or photoionization. A recent configuration has been published in which a gas chromatograph was also interfaced to the API source so that either a liquid or a gas stream from a gas chromatograph could be ionized (WO 20061060130 A2, McEwen). Typically, primary ions are formed at atmospheric pressure by initiation of a gaseous electrical discharge by an electric field or by electrospray ionization (ESI) as described in U.S. Pat. No. 6,297,499 (Fenn) and; U.S. Pat. No. 5,788,166 (Valaskovic). The primary ions in turn ionize the gas phase analyte molecules by either an ion-molecule process as occurs in atmospheric pressure chemical ionization (APCI), by a charge transfer process, or by entraining the analyte molecules in a charged droplet of solvent produced in the electrospray process. In the case of analyte being entrained in a charged liquid droplet, the ionization process is the same as in electrospray ionization (ESI) because the analyte molecules are first entrained in the liquid droplets and subsequently ionized.

Electrospray ionization (ESI) is a powerful method for producing gas phase ions from compounds in solution. In ESI, a liquid is typically forced from a small diameter tube at atmospheric pressure. A spray of fine droplets is generated when a potential of several thousand volts is applied between the liquid emerging from the tube and a nearby electrode. Charges on the liquid surface cause instability so that droplets break from jets extending from the emerging liquid surface. Evaporation of the droplets, typically using a counter-current gas, leads to a state where the surface charge again becomes sufficiently high (near the Raleigh limit) to cause instability and further smaller droplets are formed. This process proceeds until free ions are generated by either the evaporation process described above or by field emission that occurs when the field strength in the small droplets is sufficiently high for field evaporation of ions to occur. Molecules more basic than the solvent being used in the ESI process are preferentially ionized. Because ESI generates gas phase ions from a liquid, it is an ideal ionization method for interfacing liquid chromatography (LC) to mass spectrometry (MS). The power of ESI for the analysis of compounds as large and diverse as proteins won the 2003 Nobel prize in Chemistry for John Fenn. The combination of ESI with MS with liquid separation methods is extremely powerful analytically and results in large numbers of LC/MS instruments being sold each year.

Because ESI is most sensitive and most suitable for basic and polar compounds, most LC/MS instrumentation incorporates an alternative atmospheric pressure ionization technique called atmospheric pressure chemical ionization (APCI) for vaporizable less polar compounds. APCI was initially developed by Horning, et al. using ⁶³Ni beta decay for ionization. See Horning, E. C.; Horning, M. G.; Carroll, D. I.; Dzidic, I.; Stillwell, R. N., New Picogram Detection System Based on a Mass Spectrometer with an External Ionization Source at Atmospheric Pressure. Anal. Chem., 1973. 45: p. 936-943. A discharge ion source has since replaced the ⁶³Ni as the source of ionization. A discharge is generated when a voltage, typically applied to a metal needle, is increased to a range where electrical breakdown (formation of free electrons and ions) of the surrounding gas occurs (typically several thousand volts). The primary use of this ionization method has been as an ionization interface between liquid chromatography and mass spectrometry. See Dzidic, I.; Carroll, D. L; Stillwell, R. N.; Horning, E. C., Comparison of Positive Ions formed in Nickel-63 and Corona Discharge Ion Sources using Nitrogen, Argon, Isobutene, Ammonia and Nitric Oxide as Reagents in Atmospheric Pressure Ionization Mass Spectrometry. Anal. Chem., 1976. 48: p. 1763-1768. This ionization method relies on evaporation of the liquid exiting the liquid chromatograph with subsequent gas phase ionization in a corona discharge. The primary ions produced in the corona discharge are from the most abundant species, typically nitrogen and oxygen from air or solvent molecules. Regardless of the initial population of ions produced in the corona discharge, diffusion controlled ion-molecule reactions will result in a large steady state population of protonated solvent ions. These ions in turn will ionize analyte molecules by proton transfer if the reaction is exothermic or by ion addition if the ion-molecule product is stable and infrequently by charge transfer reactions. While this technique tends to be more sensitive than ESI for low molecular weight and less polar compounds, it nevertheless is not sensitive for low polarity compounds and those less basic than the LC solvent. Thus, neither APCI nor ESI are good ionization methods for a large class of vaporizable low polarity compounds. For this reason, other ionization methods, such as photoionization have been applied to LC/MS to more effectively reach a subset of this class of compounds (See, for example US patents U.S. Pat. No. 7,002,146, U.S. Pat. No. 5,245,192, U.S. Pat. No. 6,646,256, U.S. Pat. No. 6,630,664, US20030111598). Photoionization at atmospheric pressure uses an ultraviolet (UV) source for ionization of gas phase molecules. Typically, a plasma-induced discharge lamp that produces radiation in the range of 100-355 nm is used to generate ionization. Such a source is sold by Synagen Corporation for use with LC/MS.

Thus, liquid chromatographs interfaced with the atmospheric pressure ionization methods of ESI and APCI are in common use and frequently the mass spectrometers associated with these ionization methods have advanced analytical capabilities such as MSⁿ (MS/MS, MS/MS/MS, etc.) and/or high mass resolution and accurate mass analysis. However, LC/MS instruments, as noted above, do not effectively address a large class of important volatile and less polar compounds. Herein is described a technique for introducing samples in a solvent either from a liquid chromatograph or discreetly from, for example, microtitre plates into an API source after removal of the solvent where they are vaporized, ionized, and subsequently mass analyzed using a mass spectrometer or size analyzed using ion mobility spectrometry. Thus, the dry, solvent-free analyte is ionized without interference from solvent suppression effects that limit other API liquid introduction methods.

To our knowledge no publication or patent has addressed introduction of analyte into an atmospheric pressure ion source of a mass spectrometer using a moving analyte transport interfaced as described herein, although two patents (U.S. Pat. No. 4,867,947 and U.S. Pat. No. 4,055,987) and numerous publications (Smith, R. D. et al., Deposition Method for Moving Ribbon Liquid Chromatograph-Mass Spectrometer Interfaces, Anal. Chem., 1981, 53, 739-740. Smith, R. D. et al., Liquid Chromatography-Mass Spectrometry with Electron Impact and Fast Atom Bombardment with a Ribbon Storage Device, Anal. Chem., 1981, 53, 1603-1611. Hayes, M. J. et al., Moving Belt Interface with Spray Deposition for Liquid Chromatography/Mass Spectrometry, Anal. Chem., 1983, 55, 1745-1752. Games, D. C. et al., A Comparison of Moving Belt Interfaces for Liquid chromatography-Mass Spectrometry, Biomed. Mass Spectrom., 1984, 11, 87-95. Stout, S. D. et al., Simplified Moving Belt Interface for Liquid chromatography/Mass Spectrometry, Anal. Chem., 1985, 57, 1783-1786. Mizuno, T. et al., Development of double Belt Type LC/MS Interface without Memory Effect, Anal. Sci., 1988, 4, 241-246. Barefoot, A. C. et al., Packed Capillary Liquid Chromatography/Mass Spectrometry Using a Moving Belt Interface, Biomed. Environ. Mass Spectrom., 1989, 18, 77-82.) describe moving belt interface designs and applications for vacuum ionization mass spectrometry. Further, the use of a hot gas for vaporization of analyte has only been described by McEwen, et. al. (See McEwen, C. N.; McKay, R. G.; Larsen, B. S., Analysis of solids, liquids, and biological tissues using solids probe introduction at atmospheric pressure on commercial LC/MS instruments, Anal. Chem., 2005, 77, 7826-7831. McEwen, C.: Gutteridge, S., Analysis of the Inhibition of the Ergosterol Pathway in Fungi using atmospheric solids analysis probe (ASAP) method, J. Am. Soc. Mass Spectrom., 2007, 18, 1274-1278.) in reference to a probe introduction of melting point tubes holding analyte into the hot gas stream from commercial ESI or APCI probes. The use of a hot gas stream for vaporization of analyte from a moving wire, ribbon, or belt has not previously been described. The use of the commercially available ESI or APCI probes which are purchased with almost all API mass spectrometers for production of the heated gas stream greatly simplifies this method and reduces its cost but is not necessary as devices for producing a heated gas stream are readily built. Elimination of vacuum locks and associated pumping required with moving belt interfaces for vacuum mass spectrometers is also a major simplification and cost reduction associated with using ATD with API ion sources. Using this technology on API mass spectrometers has all the benefits associated with this type of instrumentation known to those practiced in the art and not commonly available on vacuum ionization instruments such as high mass resolution, accurate mass measurements, and mass selected fragmentation. ATD allows rapid introduction of samples into an API source for ionization and mass analysis using robotics such as an LC autosampler or from an LC effluent. ATD is therefore useful for high throughput analyses such as used with drug discovery or as a new interface for liquid chromatography which has the advantage over other LC/MS methods in that low polarity compounds can be ionized with samples introduced without solvent as in the ATD method.

Dzidic, et al. described the use of platinum wire to introduce chloro-nitrobenzene by volatilization into a specially built API source that used ⁶³Ni as the source of ionization. The only description was that the platinum wire was resistively heated in a stream of nitrogen gas. From ion source descriptions in other publications, it is likely that the sample was introduced into the nitrogen stream outside the ion source and carried into the ionization region through a heated tube similar to the GC/API-MS experiments these authors carried out. (See Dzidic, I.; Carroll, D. I.; Stillwell, R. N., Horning, E. C., Atmospheric Pressure Ionization (API) Mass Spectrometry: Formation of Phenoxide Ions from Chlorinated Aromatic Compounds, Anal. Chem., 1975, 47, 1308-1312.). An open source experiment was reported in which a sample on a surface was ionized using charged droplets either from an electrospray device or from APCI in which the droplets were charged using a corona discharge. (See Cotte-Rodriquez, I.; Takats, Z.; Talaty, N.; Chen, H.; Cooks, R. G., Desorption Electrospray Ionization of Explosives on Surfaces: Sensitivity and Selectivity Enhancement by Reactive Desorption Electrospray Ionization, Anal. Chem., 2005, 77, 6755-6764.) The mechanism for this device is believe to be charge droplets hitting a surface with subsequent pickup of sample into smaller droplets that spatter into the gas phase with subsequent ionization. Another open source ionization method for direct analysis in real time uses an electric discharge device to produce metastable nitrogen or helium species which form reactant ions that when directed at analyte produces analyte ions (U.S. Pat. No. 7,112,785 B2, Laramee and Cody). Neither technique describes the use of heated gas to vaporize materials and both devices use open air sources which have the potential to emit hazardous gases into the surrounding area. Several patents describe multi-probe sources (US20010013579 A1, Andrien, Whitehouse, Shen, Sansone, U.S. Pat. No. 7,078,681 B2, Fischer, Gourien, Bertsch, US20060255261 A1, Whitehouse, White, Willoughby, Sheehan), but non use an ATD.

Because work in the Horning group in the 1970's developed the APCI technique, we give here some important references. A review paper by E. C. Horning, et al discusses both GC/APIMS and LC/APIMS ion sources (See Horning, E. C.; Carroll, D. I.; Dzidic, I.; Haegele, K. D.; Lin, S.-N.; Oertil, C. U.; Stillwell, R. N., Development and Use of Analytical Systems Based on Mass Spectrometry. Clin. Chem., 1977. 23(1): p. 13-21). This article shows diagrams of each ion source and refers back to two previous publications for details on LC/APIMS and on GC/APIMS. (Respectively see Carroll, D. I.; Dzidic, I.; Stillwell, R. N.; Haegele, K. D.; Horning, E. C., Atmospheric Pressure Ionization Mass Spectrometry: Corona discharge Ion Source for use in a Liquid Chromatography-Mass Spectrometry-Computer Analytical System. Anal. Chem., 1975. 47: p. 2369-2373 and see Dzidic, I.; Carroll, D. I.; Stillwell, R. N.; Horning, E. C., Comparison of Positive Ions formed in Nickel-63 and Corona Discharge Ion Sources using Nitrogen, Argon, Isobutene, Ammonia and Nitric Oxide as Reagents in Atmospheric Pressure Ionization Mass Spectrometry. Anal. Chem., 1976. 48: p. 1763-1768).

Currently available mass spectrometers do not combine LC/MS and ATD in a single instrument or use API and a moving transport interface in any fashion. The great majority of mass spectrometers are either designed for API LC/MS operation or vacuum ionization, but not both. Many laboratories will have both vacuum ionization GC/MS and API LC/MS instruments available, but a growing number of laboratories have only API LC/MS instrumentation. Therefore, it is desirable to devise an ionization source that allows commonly available LC/MS mass spectrometers to also be capable of direct sample introduction by means of a high throughput device such as the ATD. Also, a new LC/MS interface which removes solvent before introduction of sample into the API ion source would be valuable for analysis of low polarity compounds that are either not ionized by current LC/MS methods or are ionized with low sensitivity. Such an instrument would extend the coverage of compounds that can be analyzed by currently available LC/MS instruments. ATD would have the additional advantage that the advanced capabilities common in LC/MS instruments, but not common in vacuum ionization instruments (e.g. techniques known to those practiced in the art such as cone-voltage fragmentation, MSⁿ, high-mass resolution, accurate mass measurement) would become available to liquids/solids direct analysis without purchase of new and expensive instrumentation. Further, the heated gas stream used to vaporize materials reduces thermal fragmentation relative to direct resistive heating of samples off of a metal wire or ribbon. Apparently, the gas stream applies heat to the sample/air interface so that molecules are immediately removed from the surface when they attain sufficient thermal energy to overcome surface forces. The compounds vaporizing from the surface are ionized by a corona discharge or by photoionization.

### SUMMARY OF INVENTION

An ionization source useful with an atmospheric pressure mass spectrometer, the source capable of ionizing liquid effluent from a preceding separation apparatus, such as a liquid chromatograph, and of introducing the ions from the atmospheric pressure region into the vacuum region of the mass spectrometer for mass analysis of the ions, the source comprising: an ionization arrangement for generating an electric discharge, the ionization arrangement being connected to a high voltage source, or a UV lamp for producing ions by photoionization; and an enclosure for enclosing the ionization arrangement thereby defining an ionization region, the enclosure having at least one port for introducing an effluent from a source of liquid effluent and an additional port for introducing sample usually in solution into the ionization region directly on a moving wire, ribbon, or belt, and an aperture for introducing ions into the vacuum region of the mass spectrometer.

The enclosure further comprises a port for introducing a reactive gas and a vent for venting gas from the enclosure. The at least one port is for introduction of a liquid effluent for either ESI or APCI and an additional port, as described herein, for introduction of an ATD comprising a moving wire, ribbon, or belt onto which analyte is applied.

The ionization arrangement for generating an electric discharge comprises a sharp-edged or pointed electrode onto which a high voltage is applied to generate a discharge. The ionization arrangement for generating an electric discharge may comprise any arrangement in which a discharge is generated that supplies gas phase primary ions that ionize the analyte molecules by ion-molecule reactions at or near atmospheric pressure. The ionization arrangement may also comprise a suitable lamp for generating ionizing radiation such as a plasma induced discharge (PID) lamp, or other means of generating ions from vapor phase molecules at or near atmospheric pressure.

The present invention also provides a method of increasing the scope of compounds that can be analyzed at atmospheric pressure by the elimination of solvent. Liquid introduction techniques provide copious amounts of solvent to the API region. The ions formed from water or solvent undergo exothermic, but not endothermic, proton transfer reactions. Thus, only compounds more basic than the source of the ionization (solvent or more appropriately ionized solvent clusters) are ionized. This reaction series can be shown for nitrogen gas containing the solvent water;

N₂+e→N₂⁺+2e

N₂⁺+2N₂→N₄⁺+N₂

N₄⁺+H₂O→H₂O⁺+2N₂

H₂O⁺+H₂O→H₃O⁺+OH

H₃O⁺+n(H₂O)+N₂→H⁺(H₂O)ₙ+N₂

H⁺(H₂O)ₙ+A→AH⁺+nH₂O (where A=analyte).

Thus, there are many compounds that do not ionize efficiently with either ESI or liquid introduction APCI. Introducing samples on a wire, ribbon, or belt outside the ion source enclosure allows removal of solvent prior to analyte introduction into the ion source housing thus eliminating the solvent so that the ionization occurs by charge exchange from N₂⁺ or N₄⁺ or by protonation from the hydronium ([H3O]⁺) ion produced from trace amounts of moisture. Thus, for example, charge transfer reactions between the inert gas and sample can occur which increases the scope of compounds that can be ionized. Compounds such as benzene, napthalene, chlorophenol, dodecene, fluoronitrobenzene, triphenylene, and other compounds that are not ionized under liquid introduction API conditions can thus be ionized. In addition, compounds that are poorly ionized in liquid APCI or ESI are readily ionized by gas phase APCI using this methodology, thus increasing the sensitivity of analysis. Almost all vaporizable compounds can be ionized using this ATD method. The method works with either positive or negative ionization. With this method, LC/MS is more universal for vaporizable compounds.

The present invention also provides a method for adding reactive gases to the ion source region to limit the kinds of compounds that can be ionized using ATD. For example, addition of ammonia gas allows only compounds more basic than ammonia or those that form stable gas phase ion clusters with NH₄⁺ to be ionized. This can be advantageous when the compounds of interest are highly basic compounds in a matrix of less basic compounds that are not of interest. An example would be ionization of amine containing compounds in, for example, fuel oil without ionization of aromatic hydrocarbons and oxygen containing compounds. An additional advantage is that the ionization event is low energy proton transfer which eliminates or minimizes formation of fragment ions.

The present invention also provides a method for having the ATD assembly not unduly interfere with the normal operations of ESI, APCI, or APPI LC/MS. The configuration of the flange for the ATD is such that the flange and ATD assembly can readily be removed and replaced with a source closure blank flange to close the ionization region to the external atmosphere. Therefore, switching between use of the ATD assembly, ESI or APCI requires little more effort or time than switching between ESI and APCI.

The wire, ribbon, or belt of the ATD assembly is constructed of a heat resistant material that can be heated or cleaned using resistive or irradiative heating to minimize or eliminate off-gases that add to the background ion current. The preferable material of construction is metal, or a polymeric material such as cotton. The position of the flange is such that a heat resistance wire, ribbon, or belt can be inserted into the API source housing to pass within the region of ionization. The analyte is vaporized, preferably by a hot gas stream, or by resistive or irradiative heating and the gas phase analyte is ionized using an electric discharge or photoionization and mass analyzed. Residual analyte or impurities remaining on the wire, ribbon, or belt can be removed by resistive or irradiative heating.

The arrangement whereby a heated gas, preferably nitrogen, impinges on the moving wire, ribbon, or belt and thus vaporizes the compounds in the sample as it passes under the heater gas stream is such that the heated gas source can be in the location used by the ESI or APCI probes and may be the ESI or APCI probe, or it can be an alternative location, including concurrent with the moving wire, ribbon, or belt. As noted above, an alternative approach is to have a heater assembly built into the ATD assembly so that the sample is vaporized by the heat supplied to the wire, ribbon, or belt by resistive heating or radiative heating. In this configuration, metal is the preferably material of construction. The heater can be as simple as a length of wire such as nichrome or stainless steel that resists oxidation during heating at atmospheric pressure. The heater may be the moving wire or ribbon with contacts that supply electric current being near the ionization region.

The present invention provides several advantages over the current art in mass spectrometry. By using an atmospheric pressure ion source interfaced to a mass spectrometer, in accordance with the invention described herein, any API LC/MS instrumentation can be converted to a LC/API-MS instrument with additional capabilities of rapid and automated sample introduction and LC/API-MS capable of ionizing a wider range of compound types. Using the present invention, the effluent from an LC can be analyzed by ESI, APCI, APPI, or using the ATD in combination with mass spectrometry or ion mobility spectrometry and compounds inserted into the source using the ATD can likewise be analyzed. Further, the time to switch between the various methods is as short as a few minutes on most instruments.

The ion source described herein, when compared to current commercially available LC/MS instrumentation, is capable of ionizing a wider array of materials, of ionizing materials directly without sample extraction or other workup procedures. By using the method of the present invention, some chemical compound types that cannot be ionized by ESI or APCI LC/APIMS can be ionized using the ATD sample introduction method and many others are ionized with greater efficiency and sensitivity. In addition, samples can be introduced into the API source using, for example, robotics and microtitre plates, at a rate exceeding 1000 samples per hour, or from an LC effluent.

The ATD configuration at atmospheric pressure also has advantages over a vacuum moving belt interface MS. Many LC/MS instruments are capable of accurate mass measurement and selected ion fragmentation (i.e., MS/MS) whereas few instruments with ionization under vacuum conditions have such capabilities. Conversion of LC/MS instrumentation having such features to the ion source of the present invention described herein also provides these features to ATD operation. Other advantages of the AP ATD is that no vacuum stages are required to introduce samples into the ionization region and the ionization is less prone to produce fragmentation.

The present invention is a device that enables rapid sample introduction to commercially available atmospheric pressure ionization mass spectrometers (APIMS) which are designed to interface to liquid separation methods such a liquid chromatography (LC) or capillary electrophoresis (CE). The present invention provides an ion source for a mass spectrometer or ion mobility spectrometer having ATD introduction of samples as well as ESI, APCI, APPI, or ATD LC/API-MS operation on the same instrument. The primary ionization process for the compounds vaporized from ATD introduction occurs at atmospheric pressure using a discharge or by photoionization. Advantages of API ATD introduction include simple inter-conversion between ESI or APCI LC/API-MS to ATD LC/MS, fast direct sample introduction, extended range of compounds that can be analyzed by APIMS, and no vacuum limitation of the samples introduced into the ionization region.

The present invention is also useful for the analysis of compounds that have sufficient volatility (or that can be made sufficiently volatile by using derivatization methods known in the art) to vaporize under a stream of hot nitrogen gas. As an example, ATD introduction is useful for the analysis of environmental pollutants, compounds in biological tissue, forensic analyses, explosives, synthetic products, off-gas products from polymers and other solid or liquid materials, reaction products, contaminants, drugs, metabolites, lipids, fatty acids, alcohols, aldehydes, amines, amino acids, esters, ethers, halogenated compounds, glycols, isocyanates, ketones, nitrites, nitroaromatics, pesticides, phenols, phosphorus compounds, polymer additives, prostaglandins, steroids, and sulfur compounds. Many of the compound types are difficult to detect with ESI or APCI, but can readily be detected at the sub-parts per million level using the present invention.

### BRIEF DESCRIPTION OF DRAWINGS

FIG. 1 is a sectional side view of an embodiment of an API source region showing a flange for the moving transport device, the analyte transport device (ATD), a discharge needle and the LC interfaced with the atmospheric pressure ionization region;

FIG. 2 is a alternate view of an embodiment of a ATD for atmospheric pressure ionization and the associated flange for interfacing ATD assembly with an atmospheric pressure ion source;

FIG. 3a is the selected ion chromatogram of beta-carotene with 1 microliter aliquots of five 1 ppm solutions placed at intervals on a moving metal ribbon of the ATD and demonstrates that molecular ions are generated every 9 seconds. FIG. 3b shows the mass spectrum generated from one of the peaks in FIG. 3a.

### DETAILED DESCRIPTION OF THE INVENTION

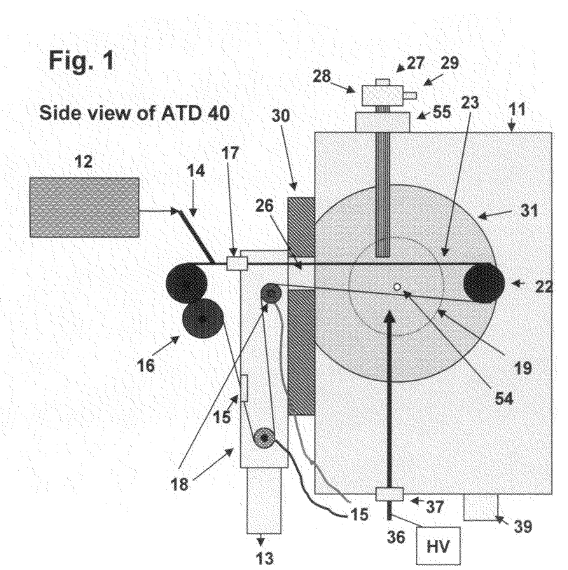

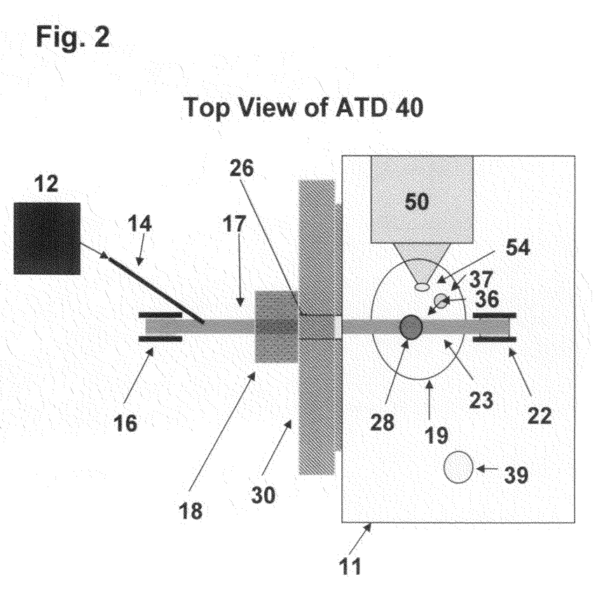

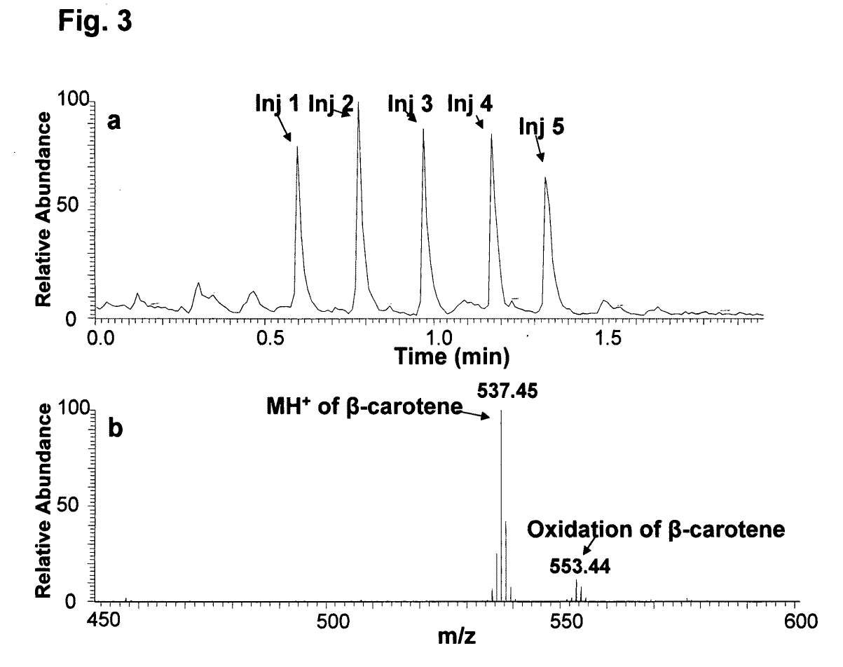

An embodiment of the present invention of interfacing an analyte transport device (ATD) to an AP-LC/MS instrument is shown in FIG. 1. FIG. 2 shows an alternative sectional view of the ATD assembly and interface flange of the earlier figure. FIG. 3 shows an application of the ATD interface demonstrating 5 injections of beta-carotene run automatically in 44 seconds.

FIG. 1 shows an atmospheric pressure ionization source 10 comprising an enclosure or housing 11, and a flange 30 for interfacing and associated ATD assembly 40 to an associated mass spectrometer ion source 10. The mass spectrometer has an entrance aperture 54, also known as a skimmer aperture, which is surrounded by the housing 11. The ionization source 10 comprises at least one port 26 for receiving the flange 30. An electrode 36, supported by an electrically insulating sleeve 37, is mounted on the enclosure 11. The electrical connection to electrode 36 extends through the wall of the enclosure and is connected to a source of high voltage HV. When the electrode 36 is energized by the high voltage source HV an electric discharge is generated within the ionization region. The volume within the enclosure 11 adjacent to the electrode 36 defines an ionization region 19. Alternatively, photo discharge UV lamp can be used in place of the discharge needle 36 to produce ions.

In the device described herein, an ATD assembly 40 using a wire, ribbon, or belt 23 to transport analyte into the ionization region 19 is held firmly to flange 30 (FIG. 1) using pulley devices 16, 18, and 22 so that the transporting wire, ribbon, or belt inserts through opening 17 and the flange opening 26, thus allowing the sample on the holding device 23 to be transported into the atmospheric pressure ionization region 19 of the mass spectrometer ion source 10. The ATD device, as shown in FIG. 1, is held so that the wire, ribbon, or belt 23 passes through entrance 17 and flange opening 26 through the heated gas stream 29A and over pulley 22 back out opening 26 over insulated pulleys 18, out opening 15 and over pulley 16 which is the drive pulley for moving 23. The heated gas 29A emanates from, for example, an APCI probe, or uses other means of heating the analyte in or near the ionization region 19 and the heated gas exits through flange opening 26 acting as a drying gas. The ESI/APCI liquid introduction probe 28 can be an interface probe between the LC 12 and the API source 10 or a specially built device to supply heated gas and fits onto port 55 of the ion source housing 11. The gas inlet 29 allows gas to enter probe 28 where the gas is heated by a heating device 33 which is a resistive heater of kinds known to those practiced in the art.

FIG. 2 shows the direct introduction ATD assembly 40 and flange 30 from a 90 degree view relative to FIG. 1. One method of applying analyte to the ATD is shown where the sample in solution is introduced from the flowing stream of liquid via a transfer line 14; the liquid stream emanating from a LC with associated autosampler 12. Sample can be injected into the liquid stream using an auto-sampler, common to LC/MS instrumentation, and with or without separation using an LC column. The solution is applied to the moving wire, ribbon, or belt 23 through a section of, for example, fused silica capillary or peek tubing 14. The wire, ribbon, or belt sample transport 23 is positioned so that the section entering the source volume passes through the heated gas stream from the LC probe 28 near the ionization region 19 to effect vaporization of the sample. Ionization is effected by a corona discharge generated using needle 36 within region 19 with the produced ions entering the AP-vacuum orifice 54 with subsequent analysis using mass spectrometer 50. Alternatively, a photoionization source can be used in place 36 to produce ions.

The moving wire, ribbon, or belt 23 of the ATD 40, (FIG. 2), when in use, a part of which is positioned near the entrance aperture 54 of the vacuum portion of the mass spectrometer 50 and in the heated gas flow from the LC probe 28 as well as in or near the ionization region 19. Vaporization of sample occurs as the wire, ribbon, or belt holding the deposited analyte moves through the hot gas stream emanating from probe 28. Ionization is initiated using an electric discharge (FIGS. 1 and 2), or by photoionization. With photoionization, a photolamp or laser capable of ionizing radiation is situated in a similar manner to the discharge needle 36. The vaporized analyte from the surface of the sample holding device 23 that is not ionized is swept out of the ionization region by the flow of a clean dry gas (such as nitrogen vapor typically from a liquid nitrogen supply) emanation from probe 28. This flow of gas, associated with the ionization region 19 having an outlet 39 open to the atmosphere but usually vented to a hood, is necessary so that chemical components vaporized from the sample holder 23 are rapidly swept through the ionization region 19 through gas outlets 39 or 26 to prevent sample carryover observed in the mass spectrometer signal. Further, the ionization region 19 preferably is enclosed to such a degree that the dry and clean heated gas, preferably nitrogen, continuously added to the ionization region 19 through the LC probe 28 minimizes the presence of water vapor and contamination within the ionization region 19. In addition, the heated gas from probe 28, when the ATD is operational, flows out of the source 10 through port 26 through which the sample enters the ion source housing 11 on the moving transport device 23 thus drying the solvent containing the analyte and preventing solvent vapor from entering the ionization region 19. Under these conditions, more chemically diverse compounds may be ionized relative to a so-called open APCI source (i.e. an ion source open to the atmosphere, or one that uses wet sources of nitrogen or other gases or in which gaseous contaminants and solvents have not been minimized). The enclosure 11 may have one or more vents to allow the added heated gas from 28 to flow out from the ionization region 19. In practice, all but vent 26 may be closed so the hot gas flows from the source through the entrance and exit hole(s) 26 in flange 30 through which the wire, ribbon, or belt of the ATD passes thus providing heated gas to vaporize the solvent and sweep the solvent vapors away from the ionization region 19. In some cases additional heated gas may be supplied to dry the solvent containing the analyte. When the ATD assembly 40 is removed, the source can be sealed with a blank flange to allow normal ion source operation in the ESI or APCI modes.

This invention provides a means for producing a more universal ion source for rapid sample introduction or LC/MS of vaporizable compounds than has previously been available to mass spectrometry. As shown in FIG. 1, a typical LC/MS ion source that has interchangeable ESI and APCI probes, 28, can be modified for API ATD operation by adding a separate introduction flange 30 for the ATD to mass spectrometry interface so that the ATD assembly 40 is interfaced to the mass spectrometer 50 as shown in FIGS. 1 and 2. This flange port is typically available on commercial API ions sources for use with photoionization. When the ATD device 40 is not being used, it can easily be removed and replaced with a blank flange allowing unhindered ESI or APCI operation.

The term ‘analyte transport device (ATD) refers to a device for introducing compounds into a mass spectrometer ionization region. A similar device was used with electron and chemical ionization sources and required vacuum locks and pumping regions to allow sample to be introduced into the high vacuum of these source types. Because of the high vacuum requirement, the holes through which the belt transported sample required close tolerances and often resulted in sample carryover problems associated with the belt, and thus sample, contacting the walls of the pumping regions. The ATD device does not require close proximity of the analyte transport mechanism with the holes through which the wire, ribbon, or belt pass through the flange 30 into and out of the source enclosure 11.

Typically, ionization is initiated by an electric discharge and can use the same high voltage electronics and discharge electrode 36, usually in the form of a metal needle, which is available with commercial APCI ion sources designed to interface with a LC. Alternatively, if only an ESI source is available, an electric discharge can be initiated by placing an electrically conductive material such as a needle or a drawn metal-coated capillary in place of the electrospray capillary. With a sharp tip, discharges are generated in the voltage range used by the ESI source. In a typical discharge ionization source, the primary ionization processes involves stripping of electrons from abundant gaseous species for positive ionization, or for negative ionization electron resonant or dissociative electron attachment to the most abundant electronegative gaseous components. The electron stripping process produces positive ions that undergo further reactions during collisions and result in charge transfer where thermodynamically favored. For water vapor, hydronium ions are produced which undergo further collisions resulting in production of protonated water clusters, (i.e. [(H₂O)ₓ]H⁺). These gas phase reactions are diffusion controlled and at atmospheric pressure collisions occur on a very short time scale so that the ionization cascade causes most of the available charge to reside on the more basic molecules. Because of the abundance of water vapor or even more basic substances such as solvent and contaminants in APCI, only compounds more basic than, for example, the protonated water clusters become ionized.

This cascading effect can be used to advantage by for example adding a reactive gas 66 or liquid 67, through the inlet 27 of the LC ESI or APCI probe 28 (FIGS. 1 & 2), such as ammonia gas or ammonium hydroxide solution, so that only compounds that can either attach NH₄⁺ ions or are more basic than [(NH₃)ₙ)]H⁺ will be ionized. Alternatively, adding no gas or liquid through the inlet 27 reduces the amount of vapor in the ionization region 19 so that higher energy species are available for ionization. Under these conditions compounds such as methylcyclohexanone, naphthalene, dimethylphenol, dinitrobenzene, chloromethylphenol, fluoronitrobenzene, triphenylene, and even hydrocarbons, which do not ionize or ionize poorly under positive ion ESI or APCI LC/API conditions, ionize readily.

Ionization may also be generated using a UV lamp with photo-energy output between about 8 and 12 electron volts (eV). In photoionization, ionization occurs by stripping an electron from those molecules in which the ionization potential is below the eV output of the UV lamp source. Photoionization light sources are covered by a number of patents, for example U.S. Pat. No. 5,338,931, U.S. Pat. No. 5,808,299, U.S. Pat. No. 5,393,979, U.S. Pat. No. 5,338,931, U.S. Pat. No. 5,206,594. Even though the molecules of interest are ionized directly, they can lose charge by ion-molecule reactions, as described above, to water and other contaminants in the ionization region. Alternatively, ionization and vaporization may be generated using a laser.

Alternatively, ionization can be produced from an ESI capillary as described in U.S. Pat. No. 6,297,499. Sensitivity may be enhanced by use of lower flow rates of liquid through the capillary. Therefore, nanospray as described in U.S. Pat. No. 5,788,166 by Valaskovic, et al. appears to produce the most sensitive results using this method of ionization. Commercially available nanospray needles can operate for many hours with just a few microliters of solvent and is a simple solution for production of primary ions. By using the nanospray needle in the typical manner used for nano-electrospray, but using a pure solvent such as methanol, water, acetonitrile or mixtures thereof, the gas phase analyte molecules vaporized from the probe described herein become entrained in the liquid droplets and are ionized by the electrospray process described above. This ionization mode is more selective as to the types of compounds that can be ionized and generally produces only quasi-molecular ions with little or no fragmentation. The advantage of this ionization process is that typically only [M+H]⁺ ions are produced in the positive ion mode from polar compounds that are sufficiently basic to accept a proton from the liquid media used to produce the primary ionization, assuming no thermal fragmentation. The ionization can be influenced by addition of an additive to either the solvent being used in the nanospray process or into the gas phase. For example, addition of NH₃ gas into the ionization region will cause only molecules more basic than ammonia gas to be ionized by protonation, but cationization by NH₄⁺ addition will occur with a wider variety of compounds. This allows the ionization process to be tailored to the analytical problem.

With some of these ionization methods, little fragmentation is obtained. However, when fragmentation is needed for structural elucidation it can be generated in the skimmer-cone region on the low pressure side 50 of the entrance aperture 54, (FIGS. 1 & 2) of atmospheric pressure ion sources by application of a voltage that increases the collision energy of ions in this intermediate pressure region. Alternatively, so called MS/MS or MSⁿ mass spectrometers can be used to select an ion of a specific mass using one mass analyzer followed by fragmentation of the selected ions by gas or surface collisions and then using a second mass analyzer to obtain a mass spectrum of the fragment ions. Combining MS/MS and selected ion, or multiple ion, monitoring with the ATD device described here is a powerful and highly selective tool for the analysis of trace volatile components in complex mixtures. Because a large number of mass spectrometers that are designed for LC/MS operation are capable of high accuracy mass measurement of ions, using the arrangement of the present invention these instruments can now be used to accurately measure the mass of ions produced in the gas phase by vaporization from the atmospheric pressure ATD device described herein.

Thus, the method described to produce ions, either positive or negative, from gaseous compounds at atmospheric pressure with analysis by mass spectrometry has a number of advantages over current instrumentation. For example, an ATD device can be interfaced to a commercially available LC/MS instrument. Compounds can be vaporized from the ATD device moving analyte transport by increasing the temperature of the heated gas that strikes the wire, ribbon, or moving belt as the sample moves through or near the ionization region 19. Thus, a separation of compounds is achieved that is based on the components present in a mixture being separated in elution volume by the LC column and different elution volumes being deposited in different space on the moving belt and being transported into the ionization region 19 after removal of the solvent so that separated compounds are vaporized and ionized at different times. The use of a hot gas stream to vaporize compounds has the advantage that compounds are heated at the surface rather than beneath the surface as in resistive heating. The heated gas sweeps molecules from the surface as they attain sufficient energy to escape the forces that bind them to the surface. This is a more gentle method for releasing compounds from a surface and occurs at a lower temperature than required to vaporize the molecules using resistive heating. Therefore, thermal fragmentation is reduced. Compounds ionized with these methods will have all of the analytical benefits of the mass spectrometer being employed as to generation of fragmentation and making accurate mass measurements.

FIGS. 1 and 2 show an embodiment of the invention in which an enclosure 11 is attached to a mass spectrometer 50 with an entrance aperture, or nozzle, 54 for introducing ions into the vacuum region of the mass spectrometer 50. The enclosure 11 has a arrangement for generating a gaseous discharge by applying a high voltage (typically from 1000 to 10,000 volts, preferably from 2000 to 6000 volts) to a metal needle electrode 36. A counter electrode may also be present and is typically at ground potential. The ionization region of enclosure 11 has an inlet for optional introduction of gases 66 or liquids 67 through inlet 27 of probe 28. The enclosure 11 also has a gas outlet 39 through which the gases are allowed to quickly exit the enclosed region. The gas outlet is frequently connected to a chemical hood but is normally closed when using the ATD device to force the heated gas to exit through opening 26 to aid in removing solvent from the ATD moving belt. Most of the gas exiting the source enclosure through 26 is typically swept to a vented hood device through exit 13. FIG. 1 shows a probe 28 with a connector inlet 27 for connecting an LC column or liquid/gas infusion syringe so that a liquid or gas can enter the ionization region 19. The LC column can be connected through line 14 to either the ATD device 40 as shown in FIG. 1 or to the connector inlet 27 to the ESI or APCI probe 28. The probe 28 has an internal heater 33 for heating a gas, typically nitrogen introduced through inlet 29 that is used to vaporize compounds from the ATD transport wire, ribbon, or belt 23. The wire, ribbon or belt of the ATD device 40 enters and exits the ion source enclosure 11 through apertures 17 and 15, respectively, and through the flange opening 26. Rollers such as 16 and 22 direct the wire, ribbon, or belt 23 to the ionization region 19 and directly under probe 28 that supplies heated gas 29A for vaporizing analyte. Two adjacent electrically insulated from the ATD rollers 18 can be used to apply an electric current through connection 15 to a metal wire, ribbon or belt outside the ionization enclosure 11 to heat that section between the rollers to remove any residual sample to prevent carryover. As shown, the vaporized residual sample exits through 13. Alternatively, a spool can supply the heat resistant material for the ATD for one time use. The material may be thread, string, wire, or ribbon. The discharge needle electrode 36 is typically located within 5 centimeters, and preferably within 2 cm of aperture 54.

FIGS. 1 and 2 further show an embodiment of the invention in which the ionization region enclosure 11 contains an entrance aperture, or nozzle, 54 for introduction of ions into the mass spectrometer vacuum region 53, a metal or metal coated needle-shaped electrode 36 for application of a high voltage to generate an electric discharge, or alternatively, 36 can be a nanospray capillary containing a solvent for ESI, a gas outlet, or vent, 39, and a gas inlet 29 through 28 for introducing a gas. The source enclosure 11 has a port, or opening, 55 for an LC interface probe 28 and a port 30 for receiving the ATD assembly 40. When the ATD 40 is fitted to the enclosure 11, the gas exit 39 is blocked or partially blocked to force a higher flow of heated gas 29A from the ESI, APCI, or specially made device to exit through the flange opening 26 and out through port 13.

FIG. 3a shows an example of results observed by plotting the protonated molecular ion signal obtained from application of 1 microliter of 1 part per million solutions (1 nanogram) of beta-carotene applied sequently to the moving metal ribbon of the ATD. The samples are vaporized and ionized using the ATD device 40 for rapid sample introduction. FIG. 3b is the mass spectrum obtained from one of the sample spots as it moves through the ionization region 19. The ion observed at m/z 537.45 is the protonated molecular ion of beta-carotene, a compound that is poorly ionized by either ESI or APCI requiring several times more sample to achieve comparable results. The ion at 553.44 is oxidized bet-carotene

Those skilled in the art, having the benefit of the teachings of the present invention as hereinabove set forth may effect modifications thereto. Such modifications are to be construed as lying within the contemplation of the present invention, as defined by the appended claims.

### Figures

FIG. 1: Sectional side view cutout drawing of atmospheric pressure ion (API) source showing the ATD (40) and the LC interface probe (28) (ESI or APCI).
FIG. 2: Sectional top view cutout drawing of the ATD (40) and the atmospheric pressure ion source for a mass spectrometer.
FIG. 3: (a) Base peak chromatogram of five injections of beta-carotene using the ATD interface to transfer sample into the atmospheric pressure ionization region. (b) Mass spectra of beta-carotene obtained from one injection. Injections made approximately every 10 seconds.

What is claimed is:

1. An ionization source useful for ionizing analyte at, or near, atmospheric pressure by ionizing the vapors induced by application of heat to analyte introduced directly into the ionization region from exterior of the ion region enclosure by application of the analyte in solution to a moving wire, ribbon, or belt of an analyte transport device (ATD) that transports analyte from exterior to the interior of the ion region enclosure and introducing the ions produced from the said vapors into the vacuum region of a mass spectrometer for mass analysis of the ions, the source comprising:
an ionization arrangement,
an enclosure for enclosing the ionization arrangement thereby defining an ionization region, the enclosure having at least one port for introducing a liquid effluent and an additional port for the ATD used for inserting samples into the ionization region and an aperture for introducing ions into the vacuum region of the mass spectrometer,
a port for introducing a heated gas to assist in vaporizing the analyte introduced by the ATD, the port may be the same or different from the port used for introduction of a liquid effluent for ionization by electrospray ionization, atmospheric pressure chemical ionization or atmospheric pressure photoionization, or
a means of assisting in vaporizing the analyte introduced using the ATD by means of resistive or radiative heating.

2. The ionization source of claim 1, wherein the enclosure further comprises a port for introducing a reactive gas and a vent for venting excess reactive gas from the enclosure, the port for introducing the reactive gas may be the same as the port used to introduce the liquid effluent and the reactive gas may be generated by vaporization of a liquid introduced through said port.

3. The ionization source of claim 1, wherein the port for introducing the heated gas also comprises a heater for heating the gas.

4. The ionization source of claim 1, wherein the resistive heater for vaporizing the sample is also the wire, ribbon, or belt of the ATD.

5. The ionization source of claim 1, wherein the ionization arrangement for generating an electric discharge comprises a sharp-edged or pointed electrode onto which a high voltage is applied to generate an electric gaseous discharge.

6. The ionization source of claim 1, wherein the ionization arrangement for generating UV radiation comprises a UV lamp or laser.

7. The ionization source of claim 1, further comprising a flange for accepting an ATD such that the ATD inserts a high temperature tolerant member in the form of a wire, ribbon, or belt into the ionization region, aligned so that heated gas from another probe device, typically the commercial ESI or APCI probe, strikes the member at the position in which the sample is held and within or near the ionization region and near the mass spectrometer entrance aperture, thus assisting in vaporizing compounds that comprise the sample.

8. The device of claim 7 incorporates a moving wire, ribbon, or belt to allow the sample to be moved into and out of the heated gas stream.

9. The device of claim 7, where the materials of construction are metal.

10. The device of claim 7, where the material of construction of the heat tolerant member is metal, glass, ceramic, or a heat tolerant polymer such as Kapton®.

11. The device of claim 7, where the sample positioned on the high temperature tolerant material moves within 10 cm and preferably within 2 cm of the ion entrance aperture.

12. The device of claim 7, where the exit for the source of heated gas used to vaporize the sample is within 10 cm and preferably within 2 cm of the wire, ribbon, or belt of the ATD and thus of the sample as it moves within the ionization region.

13. The device of claim 7, where the flange is made to fit an unused flange port of a commercial atmospheric pressure ion source, typically a port reserved for a photoionization lamp.

14. The device of claim 7, where the heat tolerant material is moved by a stepper motor or other similar device so that analyte introduced on the heat tolerant material is transported at a known rate into the atmospheric pressure ion source housing and into the stream of heated gas to effect vaporization of the sample.

15. The device of claim 7, where the solvent containing the analyte is introduced continuously as from a liquid chromatograph, continuous monitoring of a reaction or process, or other similar uses to the surface of the moving heat tolerant material for transport into the atmospheric pressure ion source.

16. The device of claim 7, where the solvent containing the analyte is introduced in discreet steps as by robotics or an auto-sampler, such as used with liquid chromatographs, thus applying solution from vials, microtitre plates, or similar containers onto the heat tolerant member for transport into the atmospheric pressure ion source.

17. The device of claim 7, where any solvent applied to the heat tolerant material exterior to the atmospheric pressure ion source housing is assisted in vaporization by a flow of gas, preferably heated and nonreactive gas such as nitrogen gas, so that the solvent is removed prior to analyte entering the ionization region.

18. The device of claim 7, where the heat tolerant material is a continuous loop.

19. The device of claim 7, where the heat tolerant material is wire or ribbon from a spool that passes through the source once and is discarded.

20. The device of claim 18, where heat is applied to the heat tolerant member by resistive or radiative heating to remove residual analyte and impurities as they exit the ion region enclosure and before new analyte is applied to minimize cross contamination.
